(19) United States
(12) Patent Application Publication
(10) Pub. No.: US 2005/0114317 A1
(43) Pub. Date: May 26, 2005

(54) Ordering of web search results

(76) Inventors: Manish Anand Bhide, New Delhi (IN); Ajay Kumar Gupta, New Delhi (IN); Mukesh Kumar Mahania, New Delhi (IN)

Correspondence Address: Frederick W. Gibb, III;McGinn & Gibb, PLLC, 2568-A Riva Road, Suite 304, Annapolis, MD, 21401, US

(21) Appl. No.: 10/723,498

(22) Filed: Nov. 26, 2003

(51) Int. Cl. G06F 7/00

(52) U.S. Cl. 707/3

(57) ABSTRACT

The ordered results set of a search engine based upon a search statement are processed to identify pages exhibiting patterns related to a recurring event. These pages are ranked and the ordered results set is reordered with the ranked pages appearing before those that do not exhibit the respective pattern.

### FIELD OF THE INVENTION

The present invention relates to web searching, such as is performed by search engines, and the ordering of search results.

### BACKGROUND

When searching the web, a user can be overwhelmed by thousands of results retrieved by a search engine, few of which are valuable. The search results of Web search engines are displayed according to a ranking given to each page by these search engines. Users rely heavily on such rankings to avoid having to inspect a large number of web pages.

A seminal discussion of the well-known Google™ search engine is given in a paper by Sergey Brin and Lawrence Page, “The Anatomy of a Large-scale Hypertextual Web Search”, Computer Science Department, Stanford University, Stanford, Calif. 94305, USA, November 1997 (http://www-db.stanford.edu/˜backrub/google.html). Google's ranking strategy involves, in simple terms, considering a hit list within a document for a search term, and applying weights to each according to a set of types. The search engine then counts the number of hits for each type in the hit list. Every count is converted to a count-weight, and the vector of type-weight is taken to give an IR score. The IR score is combined with a Page Rank to give a final rank to the document.

Generally, a user of a search engine is interested in web pages that are common, or relating to the same event, and search engines have difficulty discerning this interest if search terms are not precise. Users also are typically interested in the latest information about the searched keywords. Pages containing the latest information about an event are not always ranked highly by search engines due to insufficient other web pages pointing to such new web pages. It will thus commonly be the case that the pages relating to the latest information do not appear in first few pages of the search results.

For example, in the ranked results for the search query “DaWaK” given to Google™ in July 2003, the home page of DaWaK 2003 (i.e. the most recent) was the fourteenth entry, appearing on the second page of the search results. A better search result would be one in which the search results, which are related to some event, are presented based on the order of occurrence of that event. In the example given, the ordering should be done based on time.

In a paper by Eric J. Glover et al, “Web Search—Your Way”, Communications of the ACM, December 2001, Vol.44, No. 12, pp. 97-102, the authors have described a meta-search architecture that allows users to provide preferences to the search engine in the form of an information need category. Representative information need attributes include topical relevance, no. days old, average grade, word count, words per section, research paper, general score, homepage, keywords in title or domain or summary, and path length. This extra information is used to direct the search process, providing more valuable results than by considering only the query.

A meta-search agent based methodology has been proposed by Larry Kerschberg et al, “Intelligent Web Search via Personalizable Meta-search Agent”, International Conference on Ontologies, Databases and Applications of Semantics (ODBASE), 1345-1358, 2002. The methodology captures the semantics of a user's search intent in a Weighted Semantic Taxonomy Tree, transforms the semantic query into target queries for existing search engines, and ranks resulting page hits. The ranking seeks to satisfy the user's search intent, by computing relevance values from six component metrics, which are then combined into a single measure of relevance. The metrics include semantics, syntactics, categories, and popularity.

These approaches seek to improve the search results based at least in part on user-specified information.

An alternate approach is taught in U.S. Pat. No. 6,370,526 (Agrawal et al, assigned to International Business Machines Corporation), issued on Apr. 9, 2002. Agrawal et al teach use of a preference Model that is based upon a user's access actions to a group of objects. The preference model is adaptively developed using the information resources associated with a user's normal interaction with the group of objects being ranked.

### SUMMARY

The problem of the ranking of web pages is addressed based on recurring events related to a search statement. Patterns in the results set returned by a conventional search engine, that constitute such recurring events, are found, then the web pages are ranked based on an attribute of these events, such as time. The user's intention is captured without need for that intention to be specified by the user. If the search statement is directed to a point query, then the ordering of the results set is accepted without looking for a recurring event. Pages are considered to include a recurring event if a pattern is found. A pattern can be found by identifying a specific attribute near to the occurrence of a search statement element in a web page. The results set is recorded such that the pages exhibiting the pattern are placed first.

### DESCRIPTION OF DRAWINGS

FIG. 1 is a flow diagram of the general method of a search result ordering system.

FIG. 2 shows a software architecture of a search ordering system.

FIG. 3 is a block diagram of a pattern finder architecture.

FIG. 4 is a schematic representation of a computer system suitable for performing the techniques described with reference to FIGS. 1 to 3.

### DETAILED DESCRIPTION

Overview

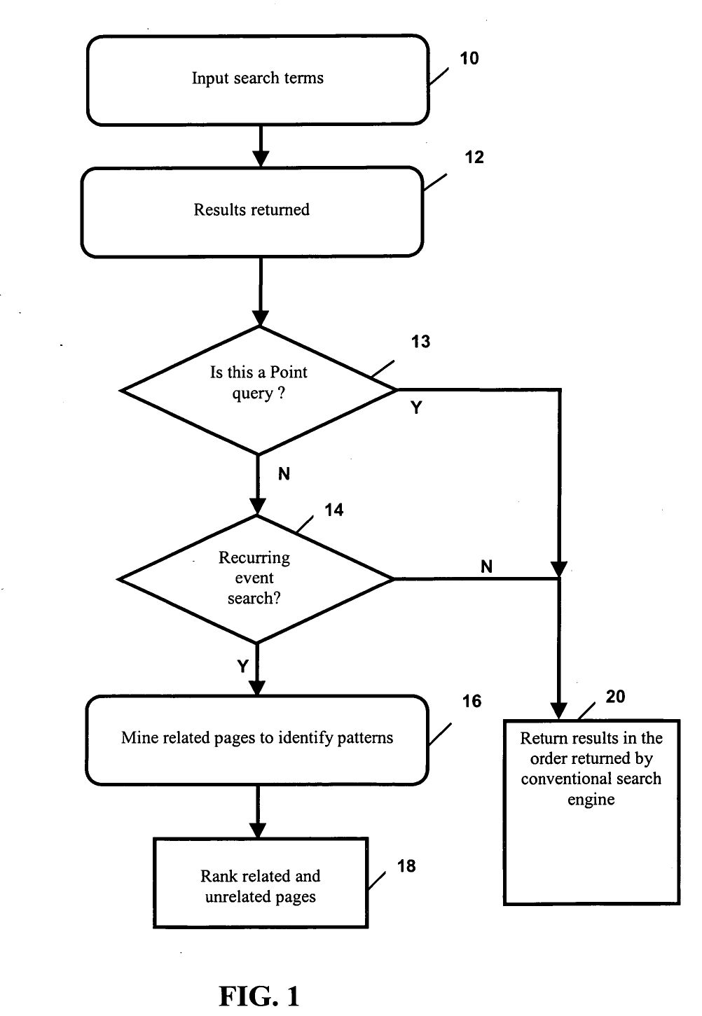

With reference then to FIG. 1, a user inputs search terms to the search engine (step 10). The search results of the search engine are returned (step 12). The user query is analyzed to determine if the user query is a point query (step 13). If the user query is a point query (meaning that if the user is interested in a specific event, and not a “recurring event”), then the search results are returned in the same order as returned by the search engine(step 20).

A point query is one in which the user query is directed to a specific event, which is determined by the presence of keywords. The keywords can be four digit numbers representing years, or Roman numerals, for example Super Bowl XVII.

If the user query is not a point query then the search result is characterized into one of two categories (step 14):
(i) having the presence of a recurring event, or
(ii) absence of any recurring event.

If the search result includes a recurring event, then the set of web pages are mined to find the pattern (step 16). A recurring event is information in the search results about the same entity occurring at different intervals of time (e.g. for a conference occurring in different years), or different versions or editions of information about the same entity (e.g. for different editions of a book). Recurring events can also represent different sets of information about an event, entity or object which may or may not be occurring at regular intervals, but are marked by an ascending or descending series of numbers (which can be numeric or alphanumeric). For example, taking the 10^{th} Conference on Data Engineering and the 11^{th} Conference on Data Engineering, the numbers 10^{th} and 11^{th} are used to detect the recurring nature of the event. A recurring event thus is indicated if keywords appear in the results that are, say, 10-15 words before or after occurrences of the user query.

The web pages are then ranked (step 18) based on the nature of the pattern. The web page for the latest event is ranked the highest, followed by those that are older, followed by those not related to the recurring event.

If the search is a point query of not a recurring event type, then the results will be output in the order ranked by the search engine (step 20).

Architecture

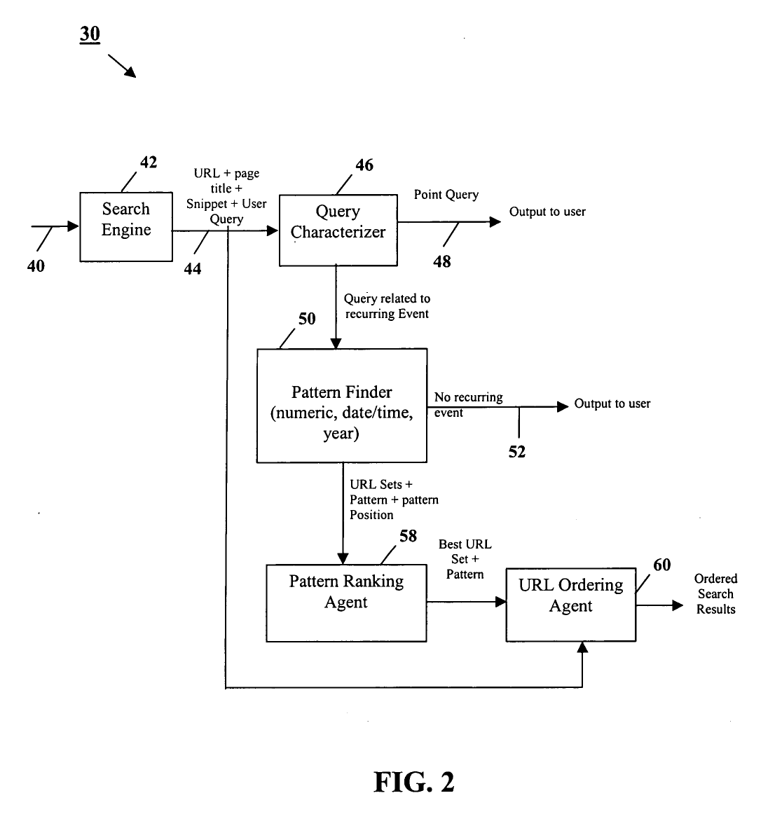

FIG. 2 is a software architecture for a search ordering system 30.

The input to the system is the user query 40, in the form of search keywords. This input is made to a conventional search engine 42. A data set 44 of the results is returned, including the web page URLs, the titles of the pages and their snippets, and these, together with the user query, are sent to a Query Characterizer 46.

If the Query Characterizer 46 identifies that the user query is not a point query according to the test stated, then the data set 44 is sent to a Pattern Finder 50. If the user query is for a point query, then the Query Characterizer 46 returns the output results 48 directly to the user with the conventional ranking.

The Pattern Finder 50 is responsible for finding that set of web pages (from the input set of web-pages), which contains information about the recurring event. The Pattern Finder 50 can operate on the basis of numeric, date/time and year attributes, for example. Generally only one set of patterns will be present in a search result. However, it is possible there will be multiple sets of patterns present in the result.

A naïve way of finding a pattern is to find the text preceding or following the searched key words in the web pages. That is, if the searched key words are related to a pattern, then the pattern is generally present in the words immediately preceding or following the searched keywords in the web pages.

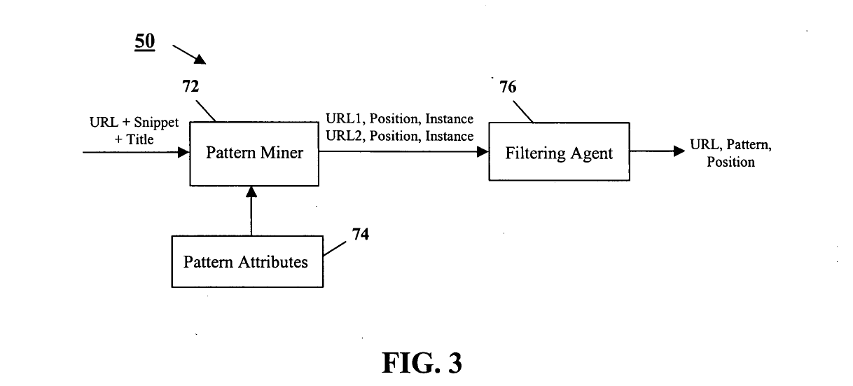

The architecture of the Pattern Finder 50 is shown in FIG. 3. The input to the Pattern Finder 50 is the output given by the search engine (i.e. the URL along with the title of the pages and the snippets). The Pattern Finder 70 is responsible for mining the patterns in the snippet and the title.

In the case of a numeric attribute, the Pattern Miner 72 will try to identify the presence of numbers “near” to the searched keywords in the snippet and the title of the page. For this the Miner 72 can search the entire snippet and the title of the search results and tag the numbers that are within some threshold (e.g. within 10 words before or after any of the searched keyword). This threshold can be set as a parameter. After tagging, the Miner 72 tries to identify if there is some repeatable pattern in the occurrence of the numbers. For example, there could be a set of web pages in which the numbers are occurring at an interval of one: In the first web page the number “20” followed by the <searched-keyword> appears and in the second page, “21” followed by the <searched-keyword> appears, and so on. This is a pattern. There could be another set of web pages in which another pattern could appear, e.g. “232 conference” followed by the <searched-keyword> in one page, and “234 conference” followed by the <searched-keyword>, where the numbers are at an interval of 2 and they start at 232. The Miner 72 tries to identify such pattern by using the following algorithm:
1) Find the minimum number that was found in the web pages,
2) Find the next higher number in the web pages, and find the difference between the two.
3) Find the next higher number and if the difference between this and the previous is the same as the difference between the first and the second, then these three form a pattern. Continue finding the next higher number, till the difference between the numbers is not the same as in the other pages. If such a break in pattern is found, then possibly there is another pattern. Take this new number (that is not a part of the pattern) and start from step 2 with this number.

When using an alphanumeric attribute, the Miner 72 will try to identify alphanumeric entities in the web pages in place of number. In the case of using a date/time attribute, the Miner 72 will try to tag dates/time in the web pages, and it will find the difference between the dates/times given in the web pages. Similarly for the year attribute: the Miner 72 will find all years given in the web pages, and it will find the difference between the years given in the web pages and identify the patterns accordingly.

The Pattern Miner 72 receives an input relating to a Pattern Attributes 74, such as the distance of the pattern from the searched keywords, minimum number of web pages that form a valid pattern etc as mentioned previously.

A Pattern Miner 72 outputs only those URLs that have the identified pattern in either the snippet or the title of the page. The Pattern Miner 72 also gives as output the position at which the pattern is found in each page (i.e. either the snippet or the title). This information is passed to a Filtering Agent 76.

Another way to implement the Pattern Miner 72 could be to make use of the directory that classifies web pages. The web pages about the recurring events in the search results are likely to have the same classification hierarchy. However, all the web pages in the search results which have the same classification will not necessarily contain information about recurring events. Hence using the classification mechanism cannot be used blindly to order the search results. In one embodiment of the invention the entire web page can be used to find the recurring pattern.

The Filtering Agent 76 is responsible for finding the correct URLs that constitute a pattern, from the set returned by the Pattern Miner 72. If no URL is returned by the Pattern Miner 72, then a pattern matching the attribute(s) is not present in the search results. If a pattern appears in the title of the web page then it should have a much higher weight than a pattern that is found in the snippet. Consider an example where the user is searching for “DaWaK”. In this case the Pattern Miner 72, operating on the date attribute, will also return pages that have the keyword “DaWaK 2001” in the body of the web page. This set of web pages might include home pages of people who have published in DaWaK 2001. However the home page of the DaWaK 2001, DaWaK 2002, and so on will have these keywords in the title of the web page. On the other hand, these keywords will not be present in the title of the web page of people who have published in DaWaK 2001 Conference. Hence if there is a set of web pages which have a pattern in the title, then such a pattern has much higher value than web pages having the key word in other parts of the page body. However, if the number of web pages having a pattern in the title is very small compared to the web pages that have a pattern in the body, then the set of web pages that have a pattern in the body is the correct pattern.

To find the correct pattern a weight is assigned to the patterns. Let the number of web pages having a pattern in the title be M, and those having a pattern in the body be N. A simple heuristic to find the right pattern could be to compare (k*M) and N, where k is the weight assigned to the pattern occurring in the title. If (k*M)>N, then the pattern is formed in M web pages, else in the N web pages. The Filtering Agent 76 outputs the set of URLs that form the pattern, information about the pattern attribute type along with the position of the pattern in the web page.

The output of the Recurring Pattern Finder 50 is provided to the Pattern Ranking Agent 58. The output is the URL sets exhibiting particular patterns, the patterns, and the position of the pattern in the respective web pages. Given a set of matching patterns, the Pattern Ranking Agent 58 is responsible for finding the best pattern that captures the user's intentions.

If the user is not searching for information about a recurring event, then the Pattern Finder 50 might return a set of noise patterns. In such a case, the Pattern Ranking Agent 58 discerns that no possible pattern fits the given search results and the results are returned to the user in the order determined by the conventional search engine. Noise patterns can be identified by attributes such as the number of web pages that constitute the pattern, the proximity of the pattern to the searched keywords in the web page, and irregularity of the position of the keywords in the web pages. All these values can be parameters which can be fixed based on the requirements of a domain. For example, if only two documents are returned by the Pattern Finder 50 operating on a numeric attribute, and if ten documents are returned by the Pattern Finder 50 operating on a date/time attribute, then the Pattern Ranking Agent 58 will infer that the pattern returned is a noise pattern. Further, if a pattern returned by a Pattern Finder 50 has an irregularity in the position at which the pattern appers in the set of web pages, then most likely the pattern is a noise pattern. For example, if the searched keyword is “KDD”, and in one of the pages the keyword “9^{th} KDD” is appearing in the title (e.g. 9^{th} KDD Workshop) and in the other web pages the pattern is appearing in the snippet (e.g. “10^{th} paper in track”) then this is not the correct pattern.

Based on the characteristics of the pattern, such as the position of the recurring information in the web page, the Pattern Ranking Agent 58 assigns a rank to the pattern. For example, if the searched keyword is “ICDE”, the Pattern Finder 50 may return two sets of patterns, one which has a numeric pattern and the other that has a year pattern. The numeric pattern has patterns like “In the 9^{th} session of the Industrial Track of the ICDE conference” in one page and “This was my 10^{th} paper appearing in the ICDE conference”. Both these sentences appear in the snippet of the web page and have a numeric pattern 9^{th}, 10^{th}, and so on, which is far away from the searched keyword (ICDE). In the other set returned by the Pattern Finder 50 the year pattern is present in the title of the web page: one page has “ICDE 2001” and the other has “ICDE 2003” in the title. Hence this second pattern—in which the pattern appears closely with the searched keyword—is given a higher rank by the Pattern Ranking Agent 58 than the year pattern which appears in the snippet of the web page.

A URL Ordering Agent 60 is responsible for sorting the results in the correct order based on the presence or absence of the recurring pattern and displaying it to the user. The Pattern Ranking Agent 58 gives those URLs that satisfy the pattern the highest rank. This URL set is not the complete set returned by the search engine. Hence the URL Ordering Agent 60 merges this set with the rest of the URLs that don't satisfy any pattern. The Agent 60 obtains the original set of URLs directly from the search engine 42. The URL is used as a key to merge the search results. Using the URL as a key, the Agent 60 identifies those web pages that are not present in the pattern and merges the two sets.

Based on the pattern that is identified in the search results, the Agent 60 orders the URLs, with the web site that has information about the latest event being ranked the highest. As mentioned with reference to FIG. 1, one ordering mechanism is that the web pages that are part of the pattern being ranked the highest (with the web page having the latest information being the first in the list) and the rest of the URLs (that are not a part of the pattern) being displayed after the web pages that form the pattern. Another ordering mechanism could be that the URLs satisfying the patterns are moved to the position at which the first event of the pattern was ranked by the conventional search engine. Such an ordering mechanism would ensure that the ranking mechanism of the search engine would be altered and only a reordering of the URLs would be done below the highest ranked URL in the search result.

Comparative Performance

A comparative performance test was carried out, by which a Google™ result set was obtained and ranked according to its ranking algorithm. Secondly, the raw Google™ results were processed by a form of the system embodying the present invention. The recurring events-related web pages were identified by the presence of any form of date or year occurring in the title or in the snippet of each page within the search results. A pattern finder of the form shown in FIG. 3, based on the attributes of date and year was utilised. The Pattern Finder 72 used the first one hundred search results returned by Google™ to search for web pages that formed a pattern. The ordering mechanism chosen is that the web pages forming a pattern are moved to the first position given by Google™ to the any web page that belongs to the pattern.

The first twenty results results returned by Google™ in July 2003 for the user query “DaWaK” are, in order:

TABLE 1
DEXA DEXA DEXA
DEXA 2000
DaWaK
DaWaK 1999
Authors starting with dawak
DaWaK 2001 Paper Abstract
DaWaK 2002 Paper Abstract
DaWaK 02 TBP
Microsoft PowerPoint - dawak.ppt
Technical Program DaWaK 2002
dbworld: (DBWORLD) final Call for Paper; DaWaK ′99
dawak
Welcome @ Dawak's
(DBWORLD) DaWaK ′2003: Technical Program (Mukesh Mohania)
Dawak - Just Another Hit Record
Data Warehousing and Knowledge Discovery: 4^{th} International . . .
Dbweb.csie.ncu.edu.tw/DBLP/dblp/db/conf/dawak/dawak2000.html
DEXA DEXA DEXA
DaWaK 2002
Dblab.comeng.cnu.ac.kr˜dolphin/db/conf/dwak/dawak99.html

“DaWak 2003”—the latest information—appears at the 14^{th} position.

The first seven results returned after ordering, for the present embodiment, are shown below:

TABLE 2
DEXA DEXA DEXA
(DBWORLD) DaWaK---2003: Call for Papers
(DBWORLD) DaWaK---2003: Call for Papers (Mukesh Mohania)
(DBWORLD) DaWaK (data Warehousing and Knowledge Discovery)-
2003. . .
Technical Program DaWaK 2002
DaWaK 2001 Paper Abstract
Technical Program DaWaK 2001

The web page having the latest information about DaWaK in the 2^{nd} position in the search results returned.

Computer Hardware and Software

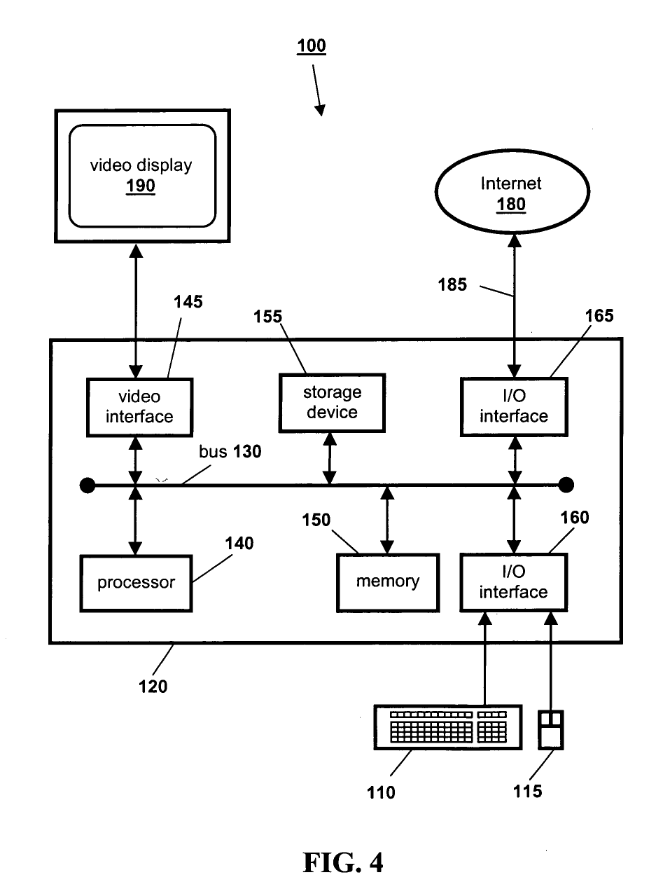

FIG. 4 is a schematic representation of a computer system 100 that can be used to implement a search engine platform operating in the manner described herein. Computer software executes under a suitable operating system installed on the computer system 100 to assist in performing the described techniques. The software will usually include a conventional search engine which interfaces with code that performs the additional functionality of the embodiments described. This computer software is programmed using any suitable computer programing language, and may be thought of as comprising various software code means for achieving particular steps.

The components of the computer system 100 include a computer 120, a keyboard 110 and mouse 115, and a video display 190. The computer 120 includes a processor 140, a memory 150, input/output (I/O) interfaces 160, 165, a video interface 145, and a storage device 155.

The processor 140 is a central processing unit (CPU) that executes the operating system and the computer software executing under the operating system. The memory 150 includes random access memory (RAM) and read-only memory (ROM), and is used under direction of the processor 140, in which software that implements the architecture described is executed.

The video interface 145 is connected to video display 190 and provides video signals for display on the video display 190. User input to operate the computer 120 is provided from the keyboard 110 and mouse 115. The storage device 155 can include a disk drive or any other suitable storage medium.

Each of the components of the computer 120 is connected to an internal bus 130 that includes data, address, and control buses, to allow components of the computer 120 to communicate with each other via the bus 130.

The computer system 100 can be connected to one or more other similar computers via a input/output (I/O) interface 165 using a communication channel 185 to a network, represented as the Internet 180.

The computer software may be recorded on a portable storage medium, in which case, the computer software program is accessed by the computer system 100 from the storage device 155. Alternatively, the computer software can be accessed directly from the Internet 180 by the computer 120. In either case, a user can interact with the computer system 100 using the keyboard 110 and mouse 115 to operate the programmed computer software executing on the computer 120.

Other configurations or types of computer systems can be equally well used to implement the described techniques. The computer system 100 described above is described only as an example of a particular type of system suitable for implementing the described techniques.

Conclusion

A benefit of the invention is obtaining an ordered search result that matches the user's intention without the user needing to state that intention.

Various alterations and modifications can be made to the techniques and arrangements described herein, as would be apparent to one skilled in the relevant art.

1. A method for ordering web search results comprising the steps of:
using a search engine returning an ordered results set for a search statement; identifying a presence of a recurring search event in said results set;
if a recurring search event is present, then identifying a pattern from said results set;
identifying related pages within the results set containing said pattern;
ranking said related pages; and
reordering said ordered set to place said related pages first.

2. The method of claim 1, including the further steps of:
identifying a presence of a point query in said search statement; and
if said point query is present, accepting said ordered results set.

3. The method of claim 2, wherein said point query is identified by a presence of keywords.

4. The method of claim 3, wherein said keywords include a form of alphanumeric characters.

5. The method of claim 4, wherein said characters include four digits.

6. The method of claim 4, wherein said characters include Roman numerals.

7. The method of claim 4, wherein said characters include a n^{th} sequence.

8. The method of claim 1, wherein said reordering step orders said related pages relatively based on rank.

9. The method of claim 1, wherein said ranking step includes determining a degree of match of each web page of the results set with said pattern.

10. The method of claim 9, where the degree of match is based upon at least one of a title, snippet, and entire content of said web page.

11. The method of claim 1, wherein said reordering is performed on a basis of time such that a most recent web page appears first.

12. The method of claim 1, wherein identifying a pattern includes setting an attribute,-and searching for said attribute near to an occurrence of at least a part of said search statement in web pages of said results set.

13. The method of claim 12, further including identifying equal incremental changes in said attribute in different web pages.

14. The method of claim 13, wherein said attribute is numeric.

15. The method of claim 13, wherein said attribute is based on a representation of any of a date, time and year.

16. The method of claim 12, wherein a nearness of an attribute is determined by a separation of N words.

17. A method for ranking web search results comprising the steps of:
identifying a presence of a recurring search event in a results set for a search statement;
identifying a pattern from said results set;
identifying related pages within the results set containing said pattern; and
ranking said related pages.

18. The method of claim 17, wherein said ranking step includes determining a degree of match of each web page of the results set with said pattern.

19. The method of claim 17, wherein identifying a pattern includes setting an attribute and searching for said attribute near to an occurrence of at least a part of said search statement in web pages of said results set.

20. A computer system for ordering web search results comprising:
an input interface operable for receiving a user specified search statement;
a processor operable for implementing a search engine to return an ordered set of search results for said search statement, and further identifying a presence of a recurring search event in said results set and if so, identifying a pattern from said results set, identifying related pages within the results set containing said pattern, ranking said related pages, and reordering said ordered set to place said related pages first; and
an output interface to output said reordered results set.

21. A computer program product comprising a computer program carried on a storage medium, said computer program comprising:
a pattern finding code element operable for identifying a presence of a recurring search event in a results set for a search statement;
a pattern identifying code element operable for identifying a pattern from said results set, and identifying related pages within the results set containing said pattern; and
a pattern ranking agent code element for ranking said related pages.

22. The computer program product of claim 21, wherein said pattern ranking agent code determines a degree of match of each web page of the results set with said pattern.

23. The computer program product of claim 21, wherein said computer program further includes a query characterizer code element for identifying a presence of a point query in said search statement, and if present, bypassing said pattern finding code element.

24. The computer program product of claim 21, wherein said computer program further includes a search engine code element for generating said results set.

25. The computer program product of claim 21, wherein said computer program further includes an ordering agent code element for ordering said results set such that said related pages come before non-related pages.
